(19) United States
(12) Patent Application Publication
(10) Pub. No.: US 2015/0113882 A1
(43) Pub. Date: Apr. 30, 2015

(54) ABRASIVE PARTICULATE MATERIAL INCLUDING SUPERABRASIVE MATERIAL HAVING A COATING OF METAL

(71) Applicant: SAINT-GOBAIN CERAMICS & PLASTICS, INC., Worcester, MA (US)

(72) Inventors: Nicholas J. Tumavitch, South Abington Township, PA (US); William Mecca, South Abington Township, PA (US); Brian C. Shaffer, Archbald, PA (US); Andrew G. Haerle, Sutton, MA (US)

(73) Assignee: SAINT-GOBAIN CERAMICS & PLASTICS, INC., Worester, MA (US)

(21) Appl. No.: 14/369,931

(22) PCT Filed: Dec. 28, 2012
(86) PCT No.: PCT/US12/72039

§ 371 Date: Jun. 30, 2014

Related U.S. Application Data
(60) Provisional application No. 61/581,792, filed on Dec. 30, 2011.

(51) Int. Cl. C09K 3/14

(52) U.S. Cl. CPC C09K 3/1436; C09K 3/1445
USPC 51/309

(57) ABSTRACT

A particulate material includes an abrasive particle having a superabrasive material with an external surface, and a coating including a metal overlying the external surface of the abrasive particle. The coating can include domains having an average domain size of not greater than about 260 nm, and the coating can include between about 1 wt % and about 20 wt % of the total weight of the abrasive particle and coating.

### BACKGROUND

1. Field of the Disclosure

The following relates to abrasive particular materials, and particularly, abrasive particulate materials including superabrasive particles having a coating of metal.

2. Description of the Related Art

The field of electroless plating of metals has been well-established and used to deposit various materials, including nickel, copper, gold, palladium, cobalt, silver, and tin, on materials for an assortment of applications. Electroless plating refers to the autocatalytic or chemical reduction of aqueous metal ions plated on a base substrate. Electroless bath compositions can be quite complex, including an aqueous solution of metal ions to be deposited, catalysts, reducing agents, stabilizers and the like.

In the electroless plating process, metal ions are reduced to metal through the action of chemical reducing agents serving as electron donors. The metal ions are electronic acceptors which react with the electron donors to form a metal which becomes deposited on the substrate. A catalyst may be present, which serves to accelerate the electroless chemical reaction to allow oxidation and reduction of the metal ion to metal. However, electroless plating does not need a current as used in conventional electroplating processes.

The industry continues to demand improved materials, and thus, improvements in methods of forming particular materials.

### SUMMARY

According to one aspect, a particulate material comprises an abrasive particle having a superabrasive material having an external surface, the abrasive particle having an median particle size not greater than about 50 microns and a coating comprising nickel overlying essentially all of the external surface of the abrasive particle in an amount within a range between about 1 wt % and about 30 wt % of the total weight of the abrasive particle and coating.

In another aspect, a particulate material includes an abrasive particle comprising a superabrasive material having an external surface, and a coating comprising a metal overlying the external surface of the abrasive particle, wherein the coating comprises domains having an average domain size of not greater than about 260 nm, the coating further comprising less than 10 macro nodules per 100 microns² of an external surface of the coating.

In yet another aspect, a particulate material includes an abrasive particle comprising a superabrasive material having an external surface, and a coating comprising a metal overlying the external surface of the abrasive particle, wherein the coating comprises domains having an average domain size of not greater than about 260 nm, and wherein the coating comprises between about 1 wt % and about 30 wt % of the total weight of the abrasive particle and coating.

Still, in another aspect, an article includes a sample of abrasive particulate material from a batch, the sample comprising at least 100 randomly selected abrasive particles comprising a superabrasive material, wherein at least about 75% of the abrasive particles comprise a conformal coating of metal overlying an external surface of the abrasive particles, and wherein the coating comprises domains having an average domain size of not greater than about 260 nm, the coating further comprising less than 10 macro nodules per 100 microns² of an external surface of the coating.

According to another aspect, a particulate material includes an abrasive particle comprising diamond having an external surface, the abrasive particle having an median particle size not greater than about 50 microns, and a coating comprising a nickel-based alloy overlying the external surface of the abrasive particle, the coating having an average thickness of not greater than about 280 nm, and wherein the coating has a thickness maxima that is not greater than about 1.5 times the average coating thickness.

In one particular aspect, a method of forming a particulate material includes providing an abrasive particle comprising a superabrasive material, the abrasive particle having an median particle size not greater than about 50 microns, and forming a conformal coating comprising a metal on the abrasive particle via plating, wherein the metal is present in an amount within a range between about 1 wt % and about 30 wt % of the total weight of the abrasive particle, and wherein forming is conducted by controlling a combination of at least two process parameter selected from the group of process parameters consisting of pH, temperature, Ni/P ratio, and a combination thereof.

### BRIEF DESCRIPTION OF THE DRAWINGS

The present disclosure may be better understood, and its numerous features and advantages made apparent to those skilled in the art by referencing the accompanying drawings.

FIG. 1 includes a schematic of the thickness of the coating as compared to the abrasive particle for an abrasive particulate material according to an embodiment.

FIG. 2 includes a representative image of a coating on an abrasive particle, wherein the coating is made of individual and discrete domains, which together form the coating according to an embodiment.

FIGS. 3-7 include images of abrasive particulate material for different samples, a portion of which represent abrasive particulate material according to an embodiment, and a portion which do not.

FIGS. 8A-8F include SEM photos for individual samplings of abrasive particulate material according to an embodiment.

FIGS. 9A-9F include SEM images for individual samplings of abrasive particulate material according to an embodiment.

FIGS. 10A-10F include SEM images for individual samplings of a conventional abrasive particulate material.

FIGS. 11A-11F include SEM images for individual samplings of a conventional abrasive particulate material.

FIGS. 12A-12F include SEM images for individual samplings of a conventional abrasive particulate material.

FIGS. 13A and 13B include SEM images of two coated abrasive particles according to an embodiment.

FIGS. 14A and 14B include SEM images of two coated abrasive particles according to an embodiment.

FIGS. 15A and 15B include SEM images of two conventional coated abrasive particles.

FIGS. 16A-16F include SEM images of conventional coated abrasive particles.

FIGS. 17A and 17B include SEM images of two conventional coated abrasive particles.

FIGS. 18A and 18B include SEM images of two different types of conventional coated abrasive particles.

The use of the same reference symbols in different drawings indicates similar or identical items.

### DETAILED DESCRIPTION

The following is directed to abrasive particulate material and methods of forming same. The abrasive particulate materials of the embodiments herein can be incorporated into various materials for different applications. For example, the abrasive particulate materials can be used in abrasive articles, such as bonded abrasive articles, coated abrasive articles, abrasive wires for slicing hard materials, sintered diamond abrasive technologies (e.g., sintered metal-bonded diamond blades), coatings, and the like.

The abrasive particulate material can be formed by initially obtaining an abrasive particle. According to one embodiment, the abrasive particle can be a superabrasive material. Suitable examples of superabrasive materials can include cubic boron nitride. In one instance, the abrasive particle can include diamond, and more particularly, can consist essentially of diamond. The diamond can be natural or synthetic.

In particular instances, the abrasive particles to be processed can be quite small in size. For example, the median particle size of the abrasive particles can be not greater than about 50 microns. In still other instances, the median particle size of the abrasive particles can be smaller, such as on the order of not greater than about 45 microns, not greater than about 42 microns, not greater than about 40 microns, not greater than about 38 microns, not greater than about 35 microns, not greater than about 32 microns, not greater than about 30 microns, not greater than about 28 microns, not greater than about 25 microns, or even not greater than about 22 microns. Still, the median particle size of the abrasive particles may be at least about 0.5 microns, at least about 1 micron, at least about 3 microns, at least about 5 microns, or even at least about 7 microns. It will be appreciated that the median particle size of the abrasive particles can be within a range between any of the minimum and maximum values noted above.

The abrasive particles can be placed in a plating bath in preparation for plating to form a coating layer on the abrasive particles. According to one embodiment, the process of forming the abrasive particulate material includes an electroless plating process. In particular, the process of the embodiments herein include a method of forming thin and conformal coating layers on the abrasive particles via plating.

Notably, the plating process may utilize a unique combination of conditions to facilitate a fast nucleation rate and slow growth kinetics. It was found that a suitable plating process according to the embodiments herein can include controlling a combination of at least two process parameters, such as pH, temperature, reducer concentration, Ni/P ratio, and a combination thereof, to facilitate suitable conditions to create thin and conformal coatings. In one particular instance, the process can include the control of a combination of at least three of the process parameters.

According to one embodiment, the abrasive particles can be placed in a bath and plating can be initiated. Plating can be conducted at a particular temperature to facilitate forming the abrasive particulate material of the embodiments herein. For example, the plating bath can maintained at a temperature of not greater than about 210° F. (99° C.), such as not greater than about 190° F. (87° C.), not greater than about 180° F. (82° C.), or even not greater than about 175° F. (79° C.). Still, in certain instances, the temperature of the plating bath can be at least about 90° F. (32° C.) at least about 100° F. (37° C.), at least about 110° F. (43° C.), at least about 120° F. (49° C.), or even at least about 130° F. (54° C.). It will be appreciated that the temperature of the bath during plating can be within a range between any of the minimum and maximum temperatures noted above.

During plating, the pH of the bath can be controlled to facilitate the proper reaction dynamics and facilitate formation of the abrasive particulate material according to the embodiments herein. For example, during plating, the pH of the bath can be generally acidic, and more notably, the pH can be not greater than about 6. For at least one particular plating process, the pH of the bath can be lower, such as not greater than about 5, not greater than about 4.5, or even not greater than about 4. Still, according to one embodiment herein, the pH may be limited, such as at least about 0.5, such as at least about 1, at least about 1.5, or even at least about 2. It will be appreciated that the pH of the bath during plating can be within a range between any of the minimum and maximum values noted above.

For one specific embodiment, the electroless metal to be deposited as a coating on the abrasive particles can include nickel. More specifically, the electroless metal can be a nickel-based alloy, such that it contains a majority content of nickel. The electroless metal may contain other elements, including for example, other transition metal elements, phosphorous, boron, and a combination thereof.

According to a particular embodiment, the metal material to be plated on the abrasive particle can contain some phosphorous. In particular instances, the amount (weight) of phosphorous added to the bath relative to the amount (weight) of nickel can be controlled to facilitate the formation of abrasive particles having the features of the embodiments herein. For example, the batch can contain a particular ratio of nickel and phosphorous, such that it can be characterized by a Ni/P ratio, wherein Ni represents the amount of Ni provided in the bath and P represents the amount of phosphorous in the bath. In one embodiment, the Ni/P ratio can be not greater than about 0.45. In other embodiments, the Ni/P ratio can be not greater than about 0.42, such as not greater than about 0.4, not greater than about 0.38, not greater than about 0.35, or even not greater than about 0.33. Still, in at least one non-limiting embodiment, the Ni/P ratio can be at least about 0.03, such as at least about 0.08, at least about 0.1, at least about 0.13, at least about 0.15, at least about 0.18, at least about 0.2, at least about 0.23, at least about 0.25, at least about 0.28, or even at least about 0.3. It will be appreciated that the Ni/P ratio can be within a range between any of the minimum and maximum values noted above.

Plating according to embodiments herein may also utilize a particular reducer material. For example, the reducer material can include sodium. In certain instances, the reducer material can be a phosphite compound, such that the reducer composition in one particular embodiment can be sodium hypophosphite.

In certain instances, the bath, and likewise the coating, may contain activators. Suitable activators can include metals, such as silver (Ag), palladium (Pd), tin (Sn), zinc (Zn). Generally, such activators are present in a minor amount such as less than about 1 wt % for the total weight of solids in the bath. In other instances, the amount of activators can be less, such as less than about 0.8 wt %, less than about 0.5 wt %, less than about 0.2 wt %, or even less than about 0.1 wt %.

Additionally, the bath, and in some instances the coating, may contain a minor content of certain impurities, including metal elements such as iron (Fe), cobalt (Co), aluminum (Al), calcium (Ca), boron (B), and chromium (Cr). One or more of the impurities may be present in a minor amount, particularly less than about 50 ppm, less than about 20 ppm, or less than about 10 ppm.

Upon completion of the plating operation, an abrasive particulate material according to an embodiment is formed that includes a superabrasive material as a core structure and a coating overlying the external surface of the superabrasive material. Notably, the plating process facilitates formation of an abrasive particulate material having a substantially thin and conformal coating. In one particular instance, the coating can be in direct contact with the external surface of the superabrasive material, and more particularly, can be bonded directly to the external surface of the abrasive particle. In still another embodiment, the coating can be a single layer bonded directly to the surface of the abrasive particle without an intervening layer between the external surface and the coating.

In still an alternative embodiment, at least a portion of the coating can be spaced apart from the external surface of the particle. For example, at least one intermediate layer can be disposed between at least a portion of the coating and the external surface of the particle. Moreover, the intermediate layer may include at least one element of the activator. In yet one particular instance, the intermediate layer can include one or more elements of an activator, and more particularly, can include a compound comprising one or more elements of the activator. For one embodiment, the intermediate layer can consist essentially of the activator.

According to one embodiment, the coating comprises a metal or metal alloy, and more particularly, can be made of a nickel-based alloy. The nickel-based alloy can contain a majority amount of nickel (by wt %). The nickel-based alloy can contain minor amounts (wt %) of other materials, including for example, transition metal elements, phosphorous, boron, and a combination thereof.

The coating can be made such that a majority amount of the total coating is amorphous phase. For example, the coating can be formed such that it consists essentially of amorphous phase nickel-alloy material. Alternatively, in certain instances, the coating may be formed such that it can be a majority content of crystalline material, and may be formed such that the coating consists essentially of a crystalline phase material.

Moreover, the coating of the embodiments herein can include an element selected from Group 15 of the Periodic Table of Elements. See, for example, IUPAC Table available at: http://old.iupac.org/reports/periodic_table/index.html. For example, the coating can include phosphorous (P). In particular instances, the coating can include a certain content of phosphorous, such as not greater than about 30% phosphorous. The amount of phosphorous can be analyzed using a ICP. In another instance, the coating can have an amount of phosphorous of not greater than about 25%, such as not greater than about 20%, not greater than about 18%, not greater than about 15%, not greater than about 14%. Still, the amount of phosphorous can be at least about 1%, at least about 3%, at least about 5%, at least about 8%, at least about 10%, or even at least about 12% for the total phosphorous content of the nickel coating. It will be appreciated that the amount of phosphorous used during plating can be within a range between any of the minimum and maximum percentages noted above.

The abrasive particular material of the embodiments herein can have a particular content of coating material. For example, the coating can be present in an amount of at least about 1 wt % for the total weight of the abrasive particle and coating. In other instances, the content of the coating material can be greater, such as at least about 2 wt %, at least about 3 wt %, at least about 4 wt %, at least about 5 wt %, at least about 6 wt %, at least about 7 wt %, at least about 8 wt %, at least about 9 wt %, or even at least about 10 wt %. Still, in another embodiment, the content of the coating can be not greater than about 30 wt %, such as not greater than about 28 wt %, not greater than about 26 wt %, not greater than about 24 wt %, not greater than about 22 wt %, such as not greater than about 20 wt %, not greater than about 19 wt %, not greater than about 18 wt %, not greater than about 17 wt %, such as not greater than about 16 wt %, not greater than about 15 wt %, not greater than about 14 wt %, not greater than about 13 wt %, such as not greater than about 12 wt %, not greater than about 11 wt %, or even not greater than about 10 wt %.

It will be appreciated that the coating can have a content within a range between any of the minimum and maximum values noted above. Some exemplary ranges include a coating can have a content within a range between about 1 wt % and about 30 wt % for the total weight of the abrasive particle and coating. In more particular instances, the coating can be present within a range between about 1 wt % and about 28 wt %, such as between 1 wt % and about 25 wt5, between about 1 wt % and about 22 wt %, between 2 wt % and about 20 wt %, such as between about 3 wt % and about 20 wt %, such as within a range between about 4 wt % and about 20 wt %, within a range between about 5 wt % and about 20 wt %, within a range between about 6 wt % and about 20 wt %, within a range between about 7 wt % and about 20 wt %, within a range between about 8 wt % and about 20 wt %, or even within a range between about 9 wt % and about 19 wt % of the total weight of the abrasive particle and coating.

The abrasive particular material of the embodiments herein can have a particular amount of coating overlying the abrasive particle. For example, a conformal coating can be formed on an abrasive particle, such that at least about 90% of the total external surface of the abrasive particle is covered by the coating material. In other cases, the coating material can overlie a greater percentage of the total surface area of the external surface, including for example, at least about 92%, at least about 93%, at least about 94%, at least about 96%, at least about 97%, at least about 98%, or even at least about 99%. In one particular embodiment, the coating can overlie essentially the entirety of the external surface area of the abrasive particle.

The coating of the abrasive particular material of the embodiments herein can be particularly thin. For example, the average thickness of the coating can be not greater than about 1000 nm, which may be measured from a suitable statistical sampling. In other embodiments, the average thickness of the coating can be not greater than about 900 nm, such as not greater than about 850 nm, not greater than about 800 nm, not greater than about 700 nm, not greater than about 650 nm, not greater than about 600 nm, not greater than about 580 nm, not greater than about 550 nm, or even not greater than about 530 nm. Still, the average thickness of the coating may be at least about 10 nm, such as on the order of at least about 20 nm, at least about 25 nm, or even at least about 30 nm. It will be appreciated that the average thickness of the coating can be within a range between any of the minimum and maximum values noted above.

According to one particular embodiment, the coating can have an average thickness of less than about 5% of the median particle size. In other instances, the average thickness of the coating can be lower, such as less than about 4.5%, less than about 4%, less than about 3.5%, less than about 3%, less than about 2.5%, less than about 2%, or even less than about 1.5%. Still, the average thickness of the coating can be limited, and may be at least about 0.05%, such as at least about 0.07%, at least about 0.09%, at least about 0.1%, at least about 0.13%, or even at least about 0.15% of the median particle size of the abrasive particle. It will be appreciated that the average thickness of the coating can be within a range between any of the minimum and maximum percentages noted above.

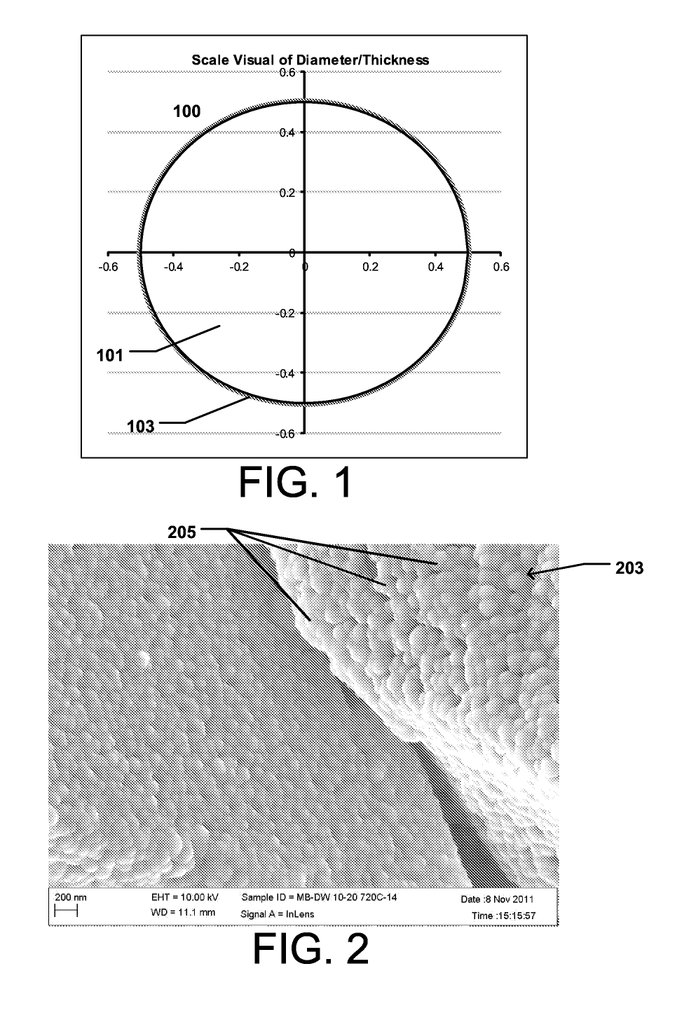

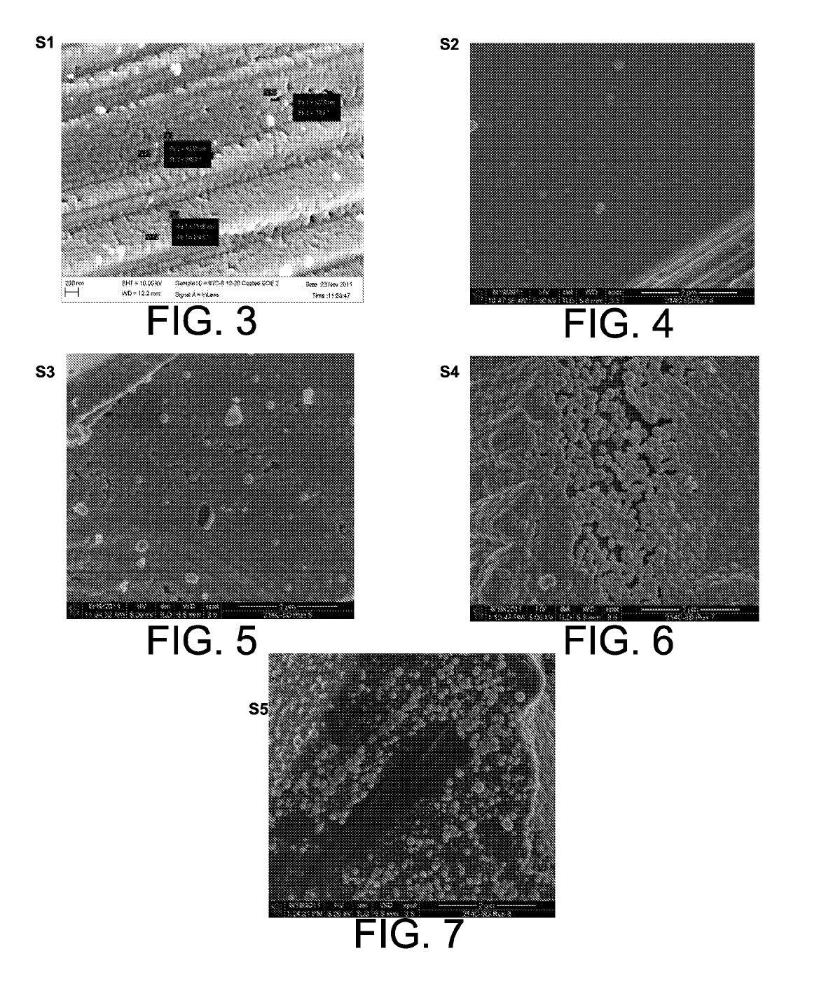

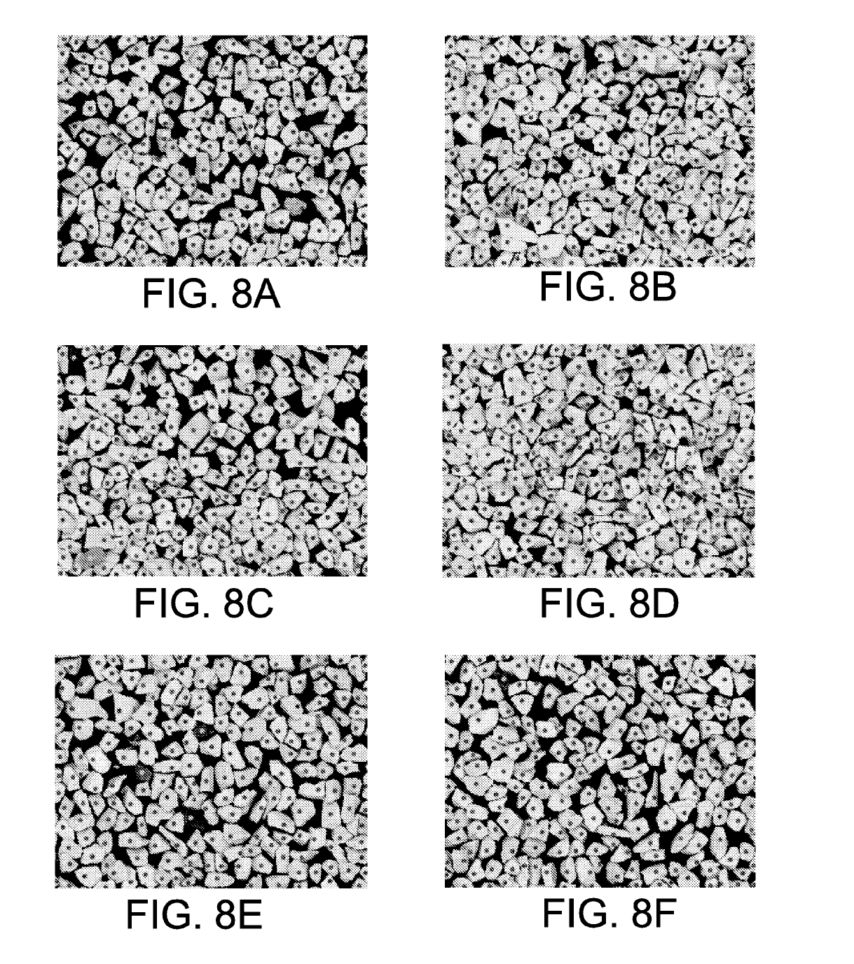

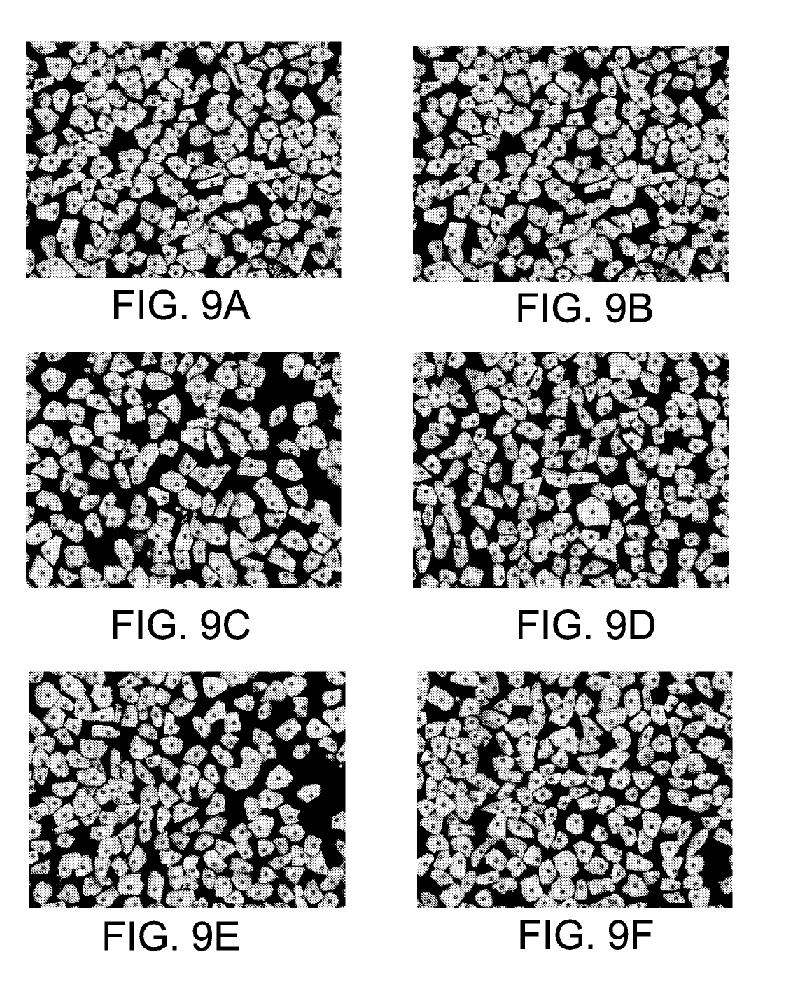

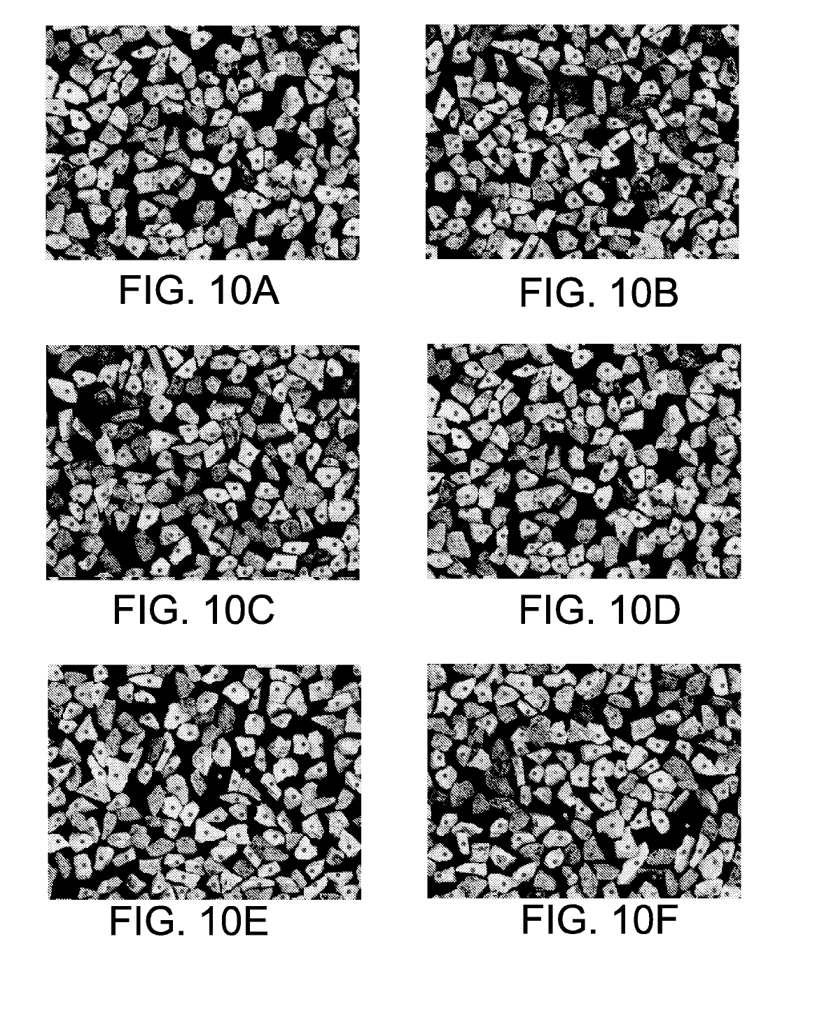

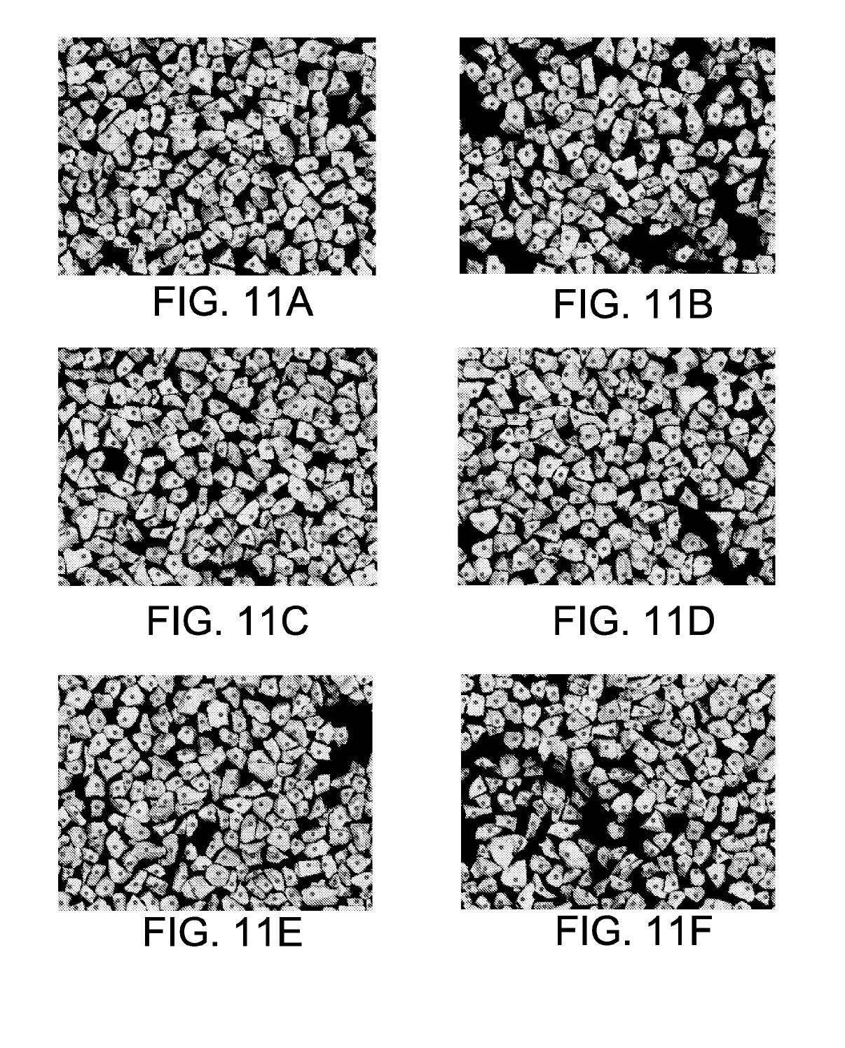

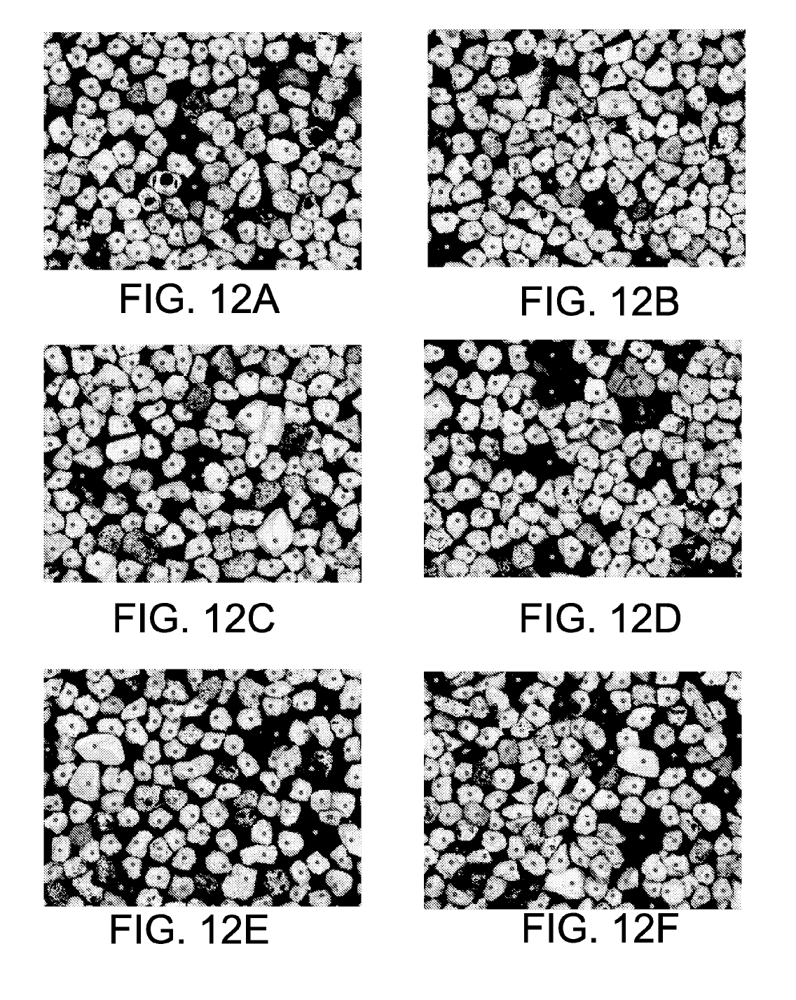

FIG. 1 includes a schematic of the thickness of the coating as compared to the abrasive particle for an abrasive particulate material according to an embodiment. As illustrated, the abrasive particulate material 100 can include an abrasive particle 100 and the coating 103 as a conformal layer overlying the abrasive particle 103. As is evident from the schematic of FIG. 1, the coating represents a very small fraction of the total content of the abrasive particulate material 100.

The coating can be formed of domains that may be identified as discrete nodules along the surface of the abrasive particle. FIG. 2 includes a representative image of a coating 203 on an abrasive particle, wherein the coating 203 is made of individual and discrete domains 205, which together form the coating 203. The domains 205 may be viewed through any suitable means, including for example, using scanning electron microscope at an appropriate magnification to resolve individual domains from each other (e.g., generally 10,000×-50,000× magnification).

According to one embodiment, the coating can include domains having an average domain size of not greater than about 260 nm. The average domain size of the domains can be measured by taking a random sampling of at least 3 domains, and more preferably, at least 6 domains, from a coating at a magnification suitable to resolve individual and discrete domains. Each of the domains can be measured to determine the longest dimension, which is the domain size for any given domain. The measurements are then averaged to calculate the average domain size for a given abrasive particle. In other instances, the average domain size can be less, such as not greater than about 250 nm, not greater than about 245 nm, not greater than about 240 nm, not greater than about 235 nm, not greater than about 230 nm, not greater than about 225 nm, or even not greater than about 220 nm. Still, the average domain size may be limited, such that it may be at least about 30 nm, such as at least about 40 nm, or even at least about 50 nm. It will be appreciated that the average domain size can be within a range between any of the minimum and maximum values noted above.

Additionally, the coating of the abrasive particulate material of the embodiments herein is particularly smooth, having a limited degree of surface abnormalities such as macro nodules. Macro nodules can be agglomerates of discrete nodules extending from the surface of the coating, and certain macro nodules may have a largest dimension of at least 10× the size of the average domain size of nodules for the coating. Macro nodules may appear as protrusions on the external surface of the coating and may be undesirable. The coatings of the embodiments herein can have a coating characterized by less than 10 macro nodules per 100 microns² of an external surface of the coating. The analysis of macro nodules can be conducted using scanning electron microscope images at an appropriate magnification (e.g., 10,000×-50,000×) to resolve macro nodules on an abrasive particulate material within a field of view large enough to encompass the desired area of the external surface. In other embodiments, the coating can have less than 9 macro nodules per 100 microns² of an external surface of the coating, such as less than 8 macro nodules per 100 microns², less than 7 macro nodules per 100 microns², less than 6 macro nodules per 100 microns², less than 5 macro nodules per 100 microns², less than 4 macro nodules per 100 microns², less than 3 macro nodules per 100 microns², less than 2 macro nodules 100 microns², or even less than 1 macro nodule per 100 microns². Still, in more particular instances, the concentration of macro nodules can be lower, such as less than 1 macro nodule per 80 microns², less than 1 macro nodule per 50 microns², less than 1 macro nodule per 30 microns², less than 1 macro nodule per 25 microns², or even less than 1 macro nodule per 10 microns². In one particular, non-limiting embodiment, the coating can be essentially free of macro nodules over the entire external surface of the coating.

The plating process of the embodiments herein may be controlled to a degree to facilitate effective formation of a thin, conformal coating on abrasive particles of a batch. A batch can represent abrasive particles having a coating made in the same, single plating process. A sample can include at least 100 randomly selected abrasive particles from a batch. According to an embodiment, a sample of abrasive particulate material from a batch can have at least about 75% of the abrasive particles within the batch characterized by a conformal coating of metal. That is, at least 75% of the abrasive particles from any sample within a batch can have a coating of metal overlying at least 90% of the external surface area of the abrasive particles. For other plating processes, a greater percentage of the abrasive particles can exhibit a conformal coating, such as at least about 80%, at least about 85%, at least about 88%, at least about 90%, at least about 92%, at least about 94%, at least about 96%, or even at least about 98% of the abrasive particles of the sample can have a conformal coating of metal.

Furthermore the process of forming the abrasive particulate material can be such that the coating on each of the abrasive particles is particularly uniform and smooth. For example, a sample from a batch of abrasive particulate material made according to an embodiment herein, can be characterized by at least 50% of the particles within the sample exhibiting no macro nodules on any portion of the external surface of the coating. In other instances, a greater percentage of particles in the sample can be free of macro nodules, for example, at least about 60% of the particles, at least about 70%, at least about 80%, at least about 90%, at least about 94%, at least about 96%, or even at least about 98% of the total particles in the sample can be free of macro nodules. In one particular embodiment, all of the abrasive particles within a sample of a batch can be essentially free of macro nodules. Evaluation of the macro nodules can be made using any suitable means, including for example, using scanning electron microscope at an appropriate magnification to resolve individual macro nodules from each other (e.g., generally 500×-50,000× magnification).

Moreover, the abrasive particulate material according to embodiments herein can have a coating exhibiting a smoothness not previously existing in conventional particles. As illustrated in a comparison of FIGS. 3 and 4, which are SEM images of representative coatings according to an embodiment, clearly the coating exhibit surprisingly smooth surfaces compared to coatings of conventional grains. In particular, the coatings of embodiments have shallow domain boundaries as compared to conventional, commercially available abrasive particulate. The domain boundaries are generally defined by dark regions separating domains. In representative embodiments, the coating is formed such that the domains are tightly packed relative to each other, and the boundaries between the domains are not as deep as in conventional samples, thus exhibiting a smoothing characteristic to the coating.

In particular instances, the smoothness of the coating has been estimated to have a roughness that is based on the relative thickness maxima relative to the average coating thickness. For example, the average thickness of the coating may be measured using suitable optical techniques (e.g., SEM) and a suitable sampling of randomly selected abrasive particles. Moreover, the average thickness maxima may be observed using suitable optical techniques, and may be the largest thickness measurement from a group of thickness measurements used to determine the average thickness. According to embodiments herein, the abrasive particulate material can include a coating having a thickness maxima that is not greater than about 1.5 times the average thickness of the coating. In other embodiments, the coating can have a thickness maxima that is less, such as not greater than about 1.4, not greater than about 1.3, not greater than about 1.2, not greater than about 1.1, or even not greater than about 1.05 of the average thickness of the coating.

The features of embodiments herein that are descriptive with respect to a feature of a particle can be representative of features associated with a sample of a batch according to an embodiment. For example, features including, but not limited to, particle size, content of the coating, average thickness of the coating, content of materials (e.g., phosphorous), number of macro nodules, average size of domains, and the like can be median values derived from a suitable random, and statistically relevant sample size of the batch.

### Example 1

Five samples (S1, S2, S3, S4, and S5) of abrasive particulate materials are made via electroless plating according to the parameters of Table 1 provided below. For each of the samples, 6000 carats of activated diamond having a median particle size of about 10-15 microns were coated under the conditions provided in Table 1. The reducer refers to the concentration of reducer (e.g., 0.276=0.276×Ni liters), Ni refers to the amount of nickel in the bath for 20 liters of water. Table 2 includes compositional features of the coating for each of the samples. The O % represents the total amount of oxygen within the coating layer for the total weight of the particle, which can be measured via standard combustion analysis using an instrument commercially available from LECO. The P % represents a percentage of phosphorous within the coating based on the total weight of the coating, which is analyzed via ICP. The Ni % represents a calculated amount of nickel in the coating based on the analysis of other components (i.e., O and P).

TABLE 1
Electroless Plating Process Parameters

| | Temp. | | Ni | Reducer | Ni/P | |
|---|---|---|---|---|---|---|
| Sample | (F.) | pH | at (17.8 g/L) | (Ni * liters) | Ratio | Coverage |
| S1 | 135 | 3.6 | 7.47 | 0.276 | 0.316 | Complete |
| S2 | 170 | 3.6 | 7.47 | 0.276 | 0.316 | Complete |
| S3 | 135 | 5.5 | 7.47 | 0.184 | 0.474 | Incomplete |
| S4 | 170 | 5.5 | 7.47 | 0.184 | 0.474 | Incomplete |
| S5 | 170 | 5.5 | 7.47 | 0.276 | 0.474 | Incomplete |

TABLE 2
Composition of the coating

| Sample | O% | P% | Ni% |
|---|---|---|---|
| S1 | 0.289 | 13.3 | 86.7 |
| S2 | 0.254 | 13 | 87 |
| S3 | 0.35 | 11.1 | 88.9 |
| S4 | 0.393 | 13.2 | 86.8 |
| S5 | 0.311 | 11.4 | 88.6 |

The evaluation of coverage is made based on the SEM analysis of the abrasive particulate material from each batch, wherein complete coverage is a measure of at least 90% of the total grains exhibiting a conformal coating. FIGS. 3-7 provide exemplary illustrations of the abrasive particulate material for samples S1-S5, respectively.

As clearly shown in FIG. 3, Samples S1 and S2 demonstrate complete coatings of the nickel-phosphorous alloy, having smooth and uniform coverage with minimal to no abnormal surface morphologies. The coating of samples S1 and S2 are 8.1 wt % and 11.7 wt % of the total weight of the abrasive particulate material, respectively.

The abrasive particulate material of samples S3, S4, and S5 do not have a conformal coating of metal, and each sample demonstrates a large portion of abrasive particles without a sufficient coating of metal. The coating of sample S3 is calculated to be 9.5 wt % of the total weight of the abrasive particulate material, the coating of S4 is 11.0 wt % of the total weight of the abrasive particulate material, and the coating of S5 is 11.6 wt % of the total weight of the abrasive particulate material.

Without wishing to be tied to a particular theory, it is thought that by controlling a combination of process parameters as provided in Table 1, suitable reaction kinetics of fast nucleation and slow growth can be achieved. Such growth kinetics appear suitable for the formation of thin, conformal coatings of metal on the abrasive particles.

### Example 2

Samples S1-S3 are further analyzed to quantify the percentage of coating for a sample of abrasive particulate material from each batch. Additional samples of conventional nickel-coated diamond particles, identified as S6 and S7 are also analyzed. S6 is a commercially available sample having a median particle size of diamonds of 30 microns having a 30 wt % coating of nickel. Sample S7 is a commercially available diamond having a median particle size of 34 microns and a 30 wt % coating of nickel.

For each batch of abrasive particulate material from Samples S2-S3, 6 different SEM photos (backscatter mode) of a sampling of abrasive particulate material are obtained at approximately 500× magnification. Each of the abrasive particles with a coating of at least approximately 90% coverage is counted as coated particles and marked in the picture. Each of the abrasive particles with a coating of less than approximately 10% coverage are counted and marked as uncoated particles. Each of the abrasive particles with a coating of between about 10%-90% coverage by visual inspection are counted as partially coated grains. While not illustrated, Sample S1 was analyzed and found to have approximately 99.3% of all abrasive particles covered particles, and only 0.7% of the abrasive particles are uncoated particles.

FIGS. 8A-8F are the SEM photos taken for a first samplings from the batch of Sample S2. Sample S2 is calculated to have approximately 99.5% of all abrasive particles covered particles and only 0.5% of the abrasive particles are uncoated particles.

FIGS. 9A-9F are SEM photos taken for a second sampling from a batch of Sample S2. Approximately 98.6% of the abrasive particles of the sample of S2 are covered particles, and only 1.4% of the abrasive particles are uncoated particles.

FIGS. 10A-10F are SEM photos taken for individual samplings from a comparative example 1, which was electroless plated in a bath having a chemistry provided in Table 3 below. Only 60.3% of the abrasive particles of the sample of comparative example 1 are covered particles, 38.8% of the abrasive particles are partially coated, and 0.8% of the abrasive particles are uncoated particles.

TABLE 3

| | Temp. | | | Reducer | | |
|---|---|---|---|---|---|---|
| Sample | (F.) | pH | N (g/L) | (Ni * liters) | Ni/P Ratio | Coverage |
| S6 | 155 | 4.6 | 17.8 | 0.184 | 0.474 | Incomplete |

FIGS. 11A-11F are SEM photos taken for individual samplings from the batch of Sample S6. Notably, the abrasive particles of diamond in sample S6 demonstrate comparative degree of covered particles (approximately 99% covered), however, it must be noted that the weight percent (i.e., 30 wt %) of the coating is significantly greater as compared to samples S1 and S2, thus increasing the coating completeness.

FIGS. 12A-12F are SEM photos taken for individual samplings from the batch of Sample S7. Interestingly, despite having a coating thickness of approximately 30 wt %, only 85% of the abrasive particles of the sample of S7 are covered particles, 6% of the abrasive particles are partially coated, and 9% of the abrasive particles are uncoated particles.

Clearly, the method of forming the abrasive particulate material according to the embodiments herein is an efficient mechanism of providing a thin, conformal coating on a vast majority of the abrasive particles treated.

### Example 3

The average domain size of Samples S1, S2, S3, S6, and S7 are measured and compared. For analysis of domain size, at least two different SEM micrographs (backscatter mode) for two different coated abrasive particles from each of the samples are obtained. A magnification suitable for resolving individual domains is used, typically 10,000×-50,000×. At least 3 domains on each of the two abrasive particles are identified at random and analyzed to determine the longest dimension. The longest dimension is measured and recorded as the domain size for the given domain. At least 6 measurements in total are taken and averaged. The resulting value is the average domain size for the sample of abrasive particulate material.

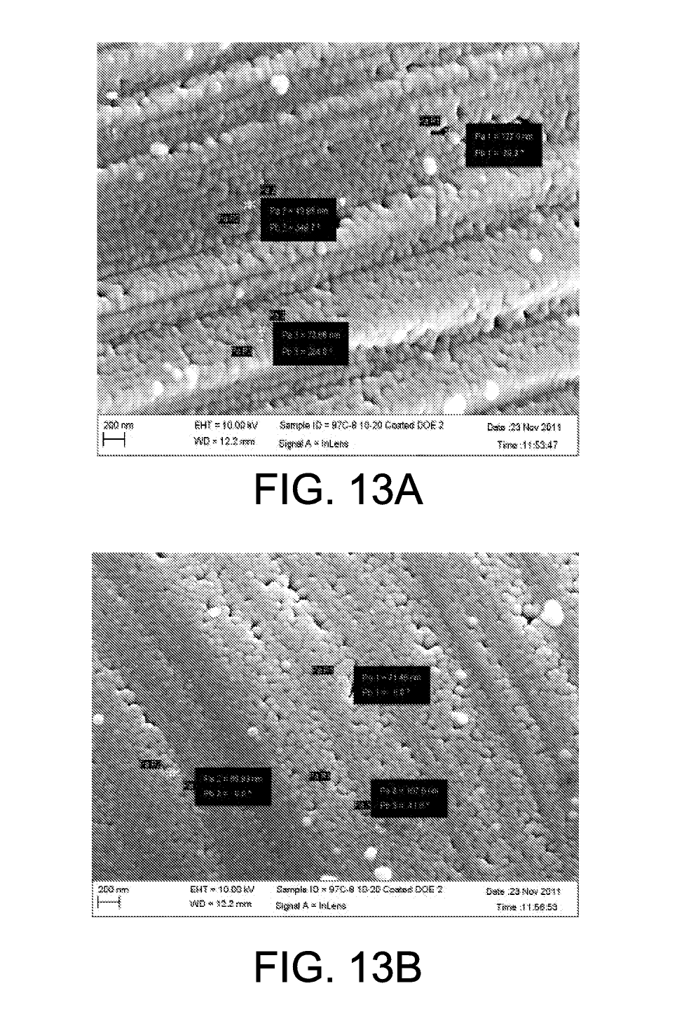

FIGS. 13A and 13B are SEM photomicrographs of two coated abrasive particles from Sample S1 as viewed at a magnification of 50,000×. As illustrated, 6 random domains are measured (3 domains from each of the particles). The average domain size of the coating of Sample S1 is calculated to be 82.8 nm.

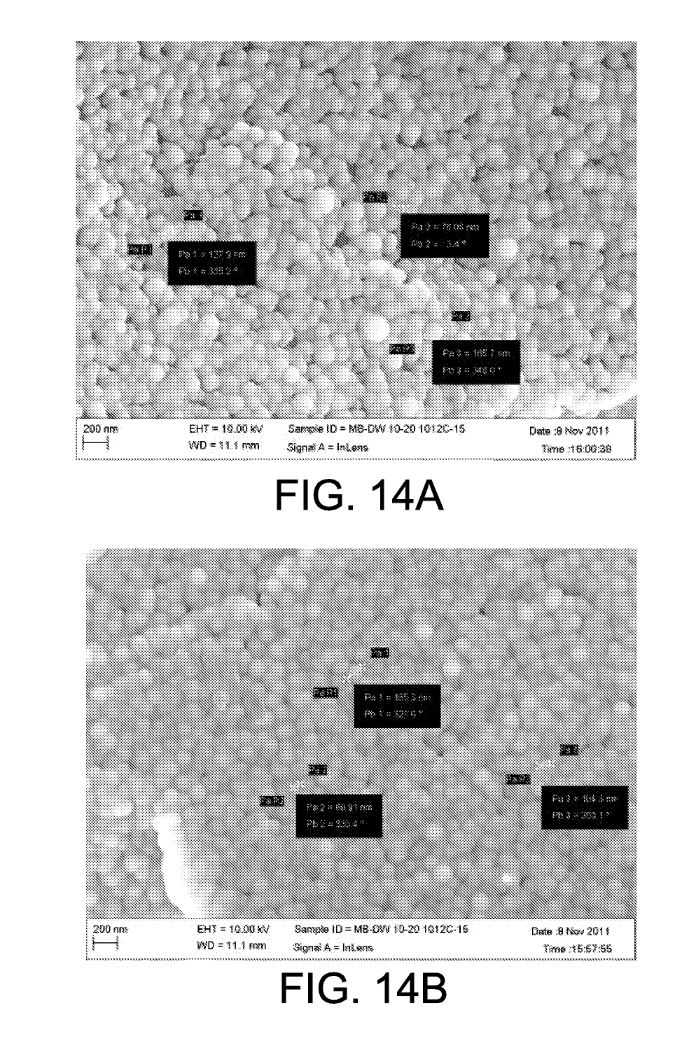

FIGS. 14A and 14B are SEM photomicrographs of two coated abrasive particles from Sample S2 as viewed at a magnification of 50,000×. As illustrated, 6 random domains are measured (3 domains from each of the particles). The average domain size of the coating of Sample S2 is calculated to be 119 nm.

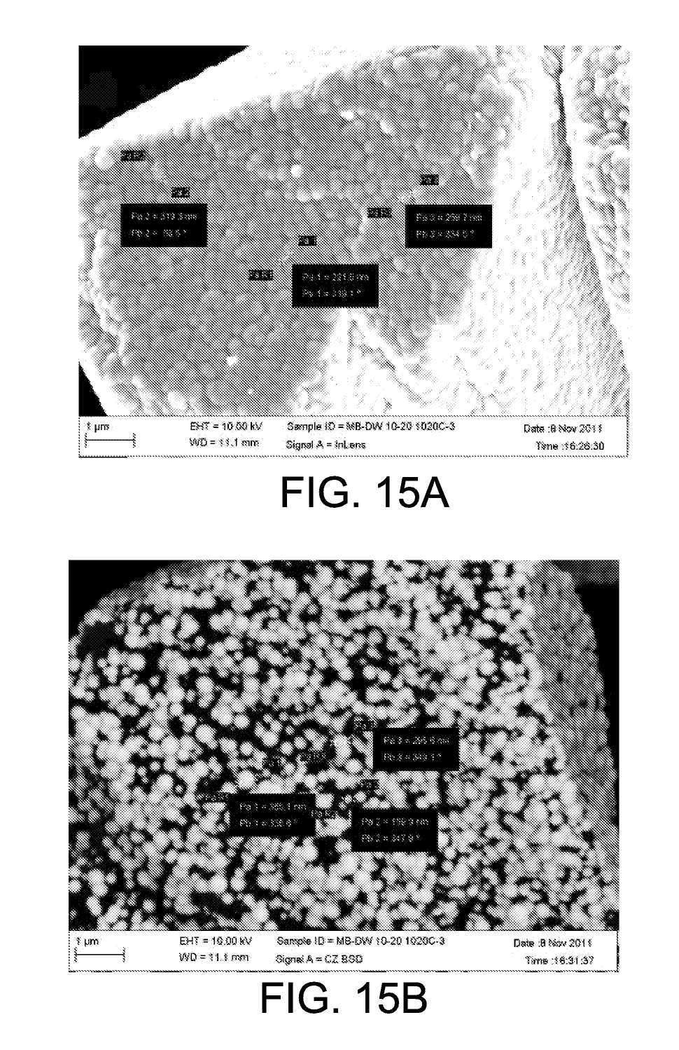

FIGS. 15A and 15B are SEM photomicrographs of two coated abrasive particles from Sample S3 as viewed at a magnification of 10,000×. As illustrated, 6 random domains are measured (3 domains from each of the particles). The average domain size of the coating of Sample S3 is calculated to be 270 nm.

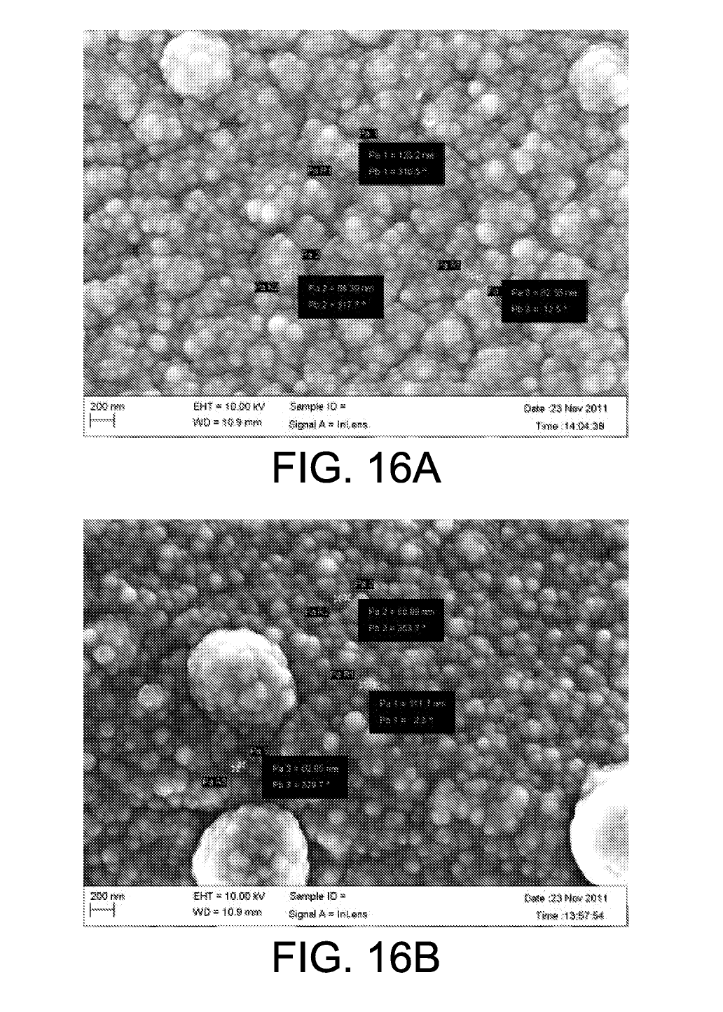

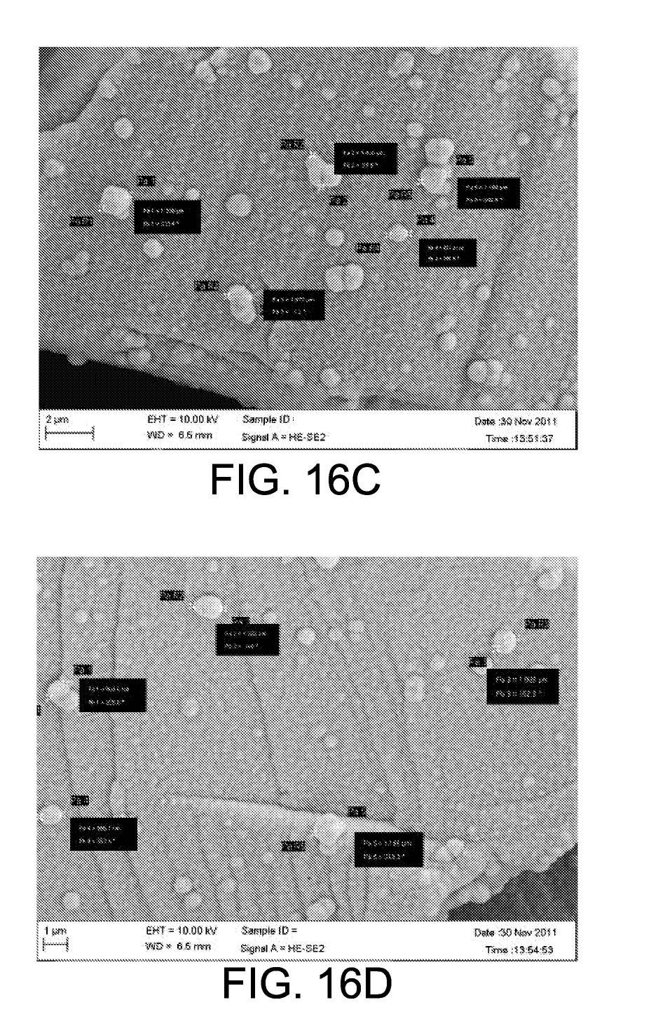

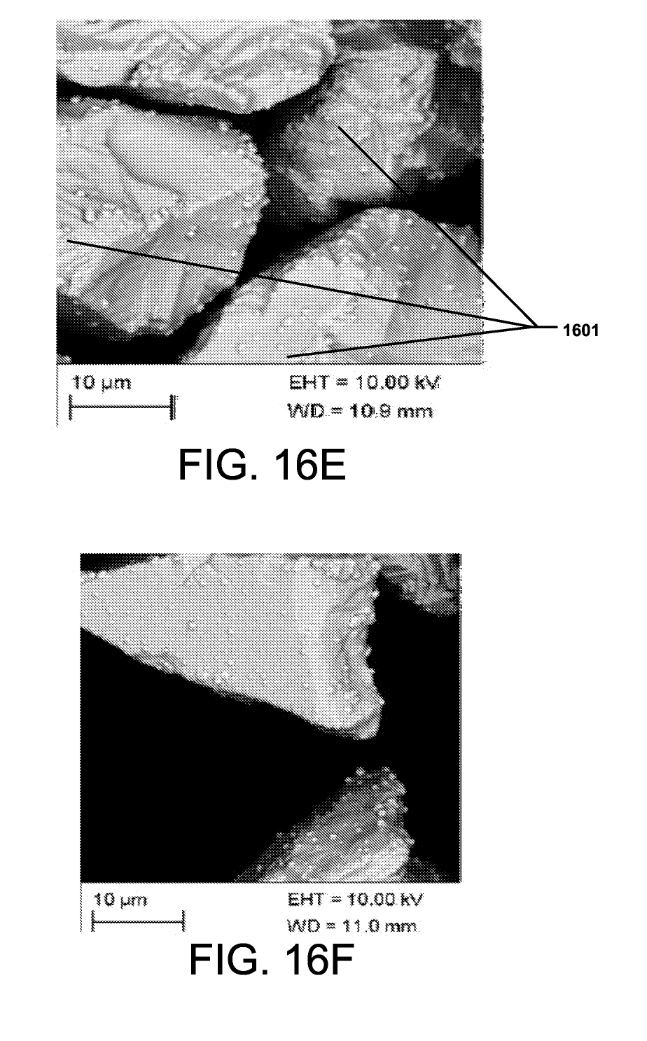

FIGS. 16A and 16B are SEM photomicrographs of two coated abrasive particles from Sample S6 as viewed at a magnification of 50,000×. As illustrated, 6 random domains are measured (3 domains from each of the particles). The average domain size of the coating of Sample S6 is calculated to be about 87 nm.

Additionally, FIGS. 16C and 16D are SEM photomicrographs of coated abrasive particles from Sample S6 as viewed at a magnification of 500×. As illustrated, the coating of Sample S6 demonstrates a high content of macro nodules. In fact, the coating of FIG. 16C has over 60 macro nodules (about 67 macro nodules) in the approximately 24 micron² area within the field of view of provided in the image. The coating of Sample S6 provided in the image of FIG. 16 D has over 40 (about 47) macro nodules in the approximately 24 micron² area within the field of view of provided in the image.

For another perspective to the concentration of macro nodules on the abrasive particles of Sample S6, FIGS. 16E and 16F are also provided, which are SEM images at a magnification of 500×. As clearly illustrated, each of the abrasive particles of Sample S6 have a many macro nodules 1601 extending from the surface of the coating and covering each of the particles in a high concentration.

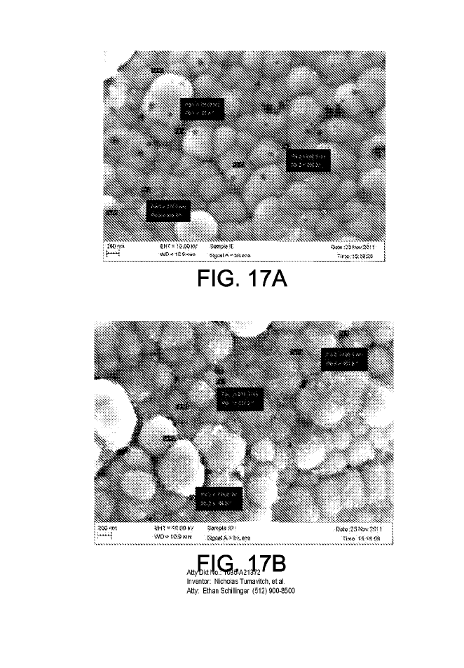

FIGS. 17A and 17B are SEM photomicrographs of two coated abrasive particles from Sample S7 as viewed at a magnification of 50,000×. As illustrated, 6 random domains are measured (3 domains from each of the particles). The average domain size of the coating of Sample S7 is calculated to be 490 nm.

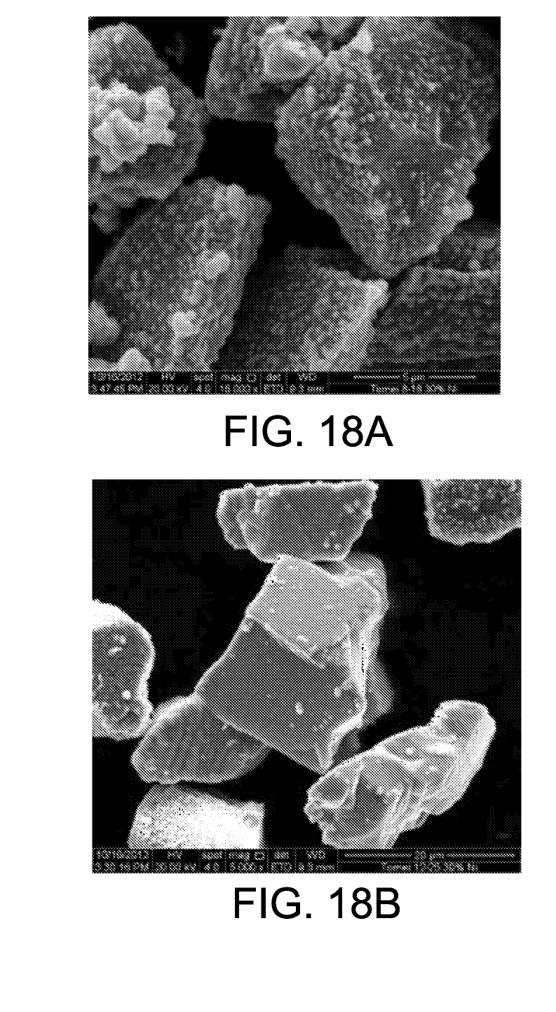

FIGS. 18A and 18B include SEM images of two different types of coated abrasive particles, commercially available from Tomei. In particular, FIG. 18A is representative of 8-16 microns sized diamond particles coated with about 19% nickel material. As clearly shown, the particles of FIG. 18A do not utilize a conformal coating of the nickel. In fact, large gaps and openings in the coating exist, exposing the external surface of many of the abrasive particles. The coating has an average domain size of 376 nm.

FIG. 18B provides an illustration of diamond having an average particle size of about 12-25 microns sized coated with about 30% nickel. As clearly shown, the particles of FIG. 18B do not utilize a conformal coating of the nickel. In fact, large gaps and openings in the coating exist, exposing the external surface of many of the abrasive particles. The coating has an average domain size of 428 nm.

Notably, the average domain size of the domains forming the coating according to the embodiments herein is significantly smaller than the domain size of coatings on conventional abrasive particulate materials. Without wishing to be tied to a particular theory, it is thought that the smaller domain sizes may be the result of the unique reaction kinetics of the plating process, which facilitates the formation of thin, conformal coatings on the abrasive particles.

The present application represents a departure from state-of-the-art coated abrasive particles. While many conventional sources of literature and patents broadly propose the achievement of thin, conformal coatings on fine abrasive particles, the actual formation of such coatings is not readily achieved in actual practice. By contrast, while not entirely understood, the applicants of the present application have found, through extensive empirical studies, that thin, conformal coatings on fine abrasive particles may be achieved by controlling a combination of process parameters as described herein. The resulting abrasive particulate material of the embodiments herein includes a combination of features not previously practiced, including extremely thin coatings, using particular materials, covering fine abrasive particles, over a vast majority of the abrasive particles within a batch and well as a vast majority of the external surface area of each of the abrasive particles, and coatings including domains of a particular domain size.

Moreover, unlike electroplated coatings, because the coating is made from an electroless process, the coatings do not exhibit build-up at edges or corners of the abrasive particles. A sharp edge receives the same thickness of deposit as a hole, resulting in a more uniform deposition of the coating on the surfaces of the abrasive particles.

The disclosure is submitted with the understanding that it will not be used to interpret or limit the scope or meaning of the claims. In addition, in the foregoing disclosure, various features may be grouped together or described in a single embodiment for the purpose of streamlining the disclosure. This disclosure is not to be interpreted as reflecting an intention that the embodiments herein limit the features provided in the claims, and moreover, any of the features described herein can be combined together to describe the inventive subject matter. Still, inventive subject matter may be directed to less than all features of any of the disclosed embodiments.

1-47. (canceled)

48. A particulate material comprising:
an abrasive particle comprising a superabrasive material having an external surface, the abrasive particle having a median particle size not greater than about 50 microns; and
a coating comprising a nickel overlying at least 90% of the external surface of the abrasive particle in an amount within a range between about 1 wt % and about 30 wt % of the total weight of the abrasive particle and coating.

49. The particulate material of claim 48 wherein the abrasive particle comprises diamond.

50. The particulate material of claim 48, wherein the coating comprises an average thickness of at least about 10 nm and not greater than about 1000 nm.

51. The particulate material of claim 48, wherein the median particle size is not greater than about 10 microns and the coating is present in an amount within a range between about 10 wt % and about 30 wt % of the total weight of the abrasive particle and coating.

52. The particulate material of claim 48, wherein the coating comprises phosphorous (P), and wherein the coating comprises a content of phosphorous of not greater than about 30% for the total content of the coating.

53. The particulate material of claim 48, wherein the coating comprises less than 1 macro nodule per 25 microns².

54. A particulate material comprising:
an abrasive particle comprising a superabrasive material having an external surface; and
a coating comprising a metal overlying the external surface of the abrasive particle, wherein the coating comprises domains having an average domain size of not greater than about 260 nm, the coating further comprising less than 10 macro nodules per 100 microns² of an external surface of the coating.

55. The particulate material of claim 54, wherein the coating comprises nickel.

56. The particulate material of claim 54, wherein the abrasive particle comprises diamond.

57. The particulate material of claim 54, wherein the coating comprises an average thickness of at least about 10 nm and not greater than about 1000 nm.

58. The particulate material of claim 54, wherein the median particle size is not greater than about 10 microns and the coating is present in an amount within a range between about 10 wt % and about 30 wt % of the total weight of the abrasive particle and coating.

59. The particulate material of claim 54, wherein the coating comprises phosphorous (P), and wherein the coating comprises a content of phosphorous of not greater than about 30% for the total content of the coating.

60. The particulate material of claim 54, wherein the coating comprises less than 1 macro nodule per 25 microns².

61. A method of forming a particulate material comprising:
providing an abrasive particle comprising a superabrasive material, the abrasive particle having an median particle size not greater than about 50 microns; and
forming a conformal coating comprising nickel on the abrasive particle via plating, wherein the coating is present in an amount within a range between about 1 wt % and about 20 wt % of the total weight of the abrasive particle, and wherein forming is conducted by controlling a combination of at least two process parameter selected from the group of process parameters consisting of pH, temperature, Ni/P ratio, and a combination thereof.

62. The method of claim 61, wherein forming is conducted by controlling a combination of at least three process parameters.

63. The method of claim 61, wherein the Ni/P ratio is not greater than about 0.45 and at least 0.03.

64. The method of claim 61, wherein the temperature is not greater than about 210° F. (99° C.) and at least about 90° F. (32° C.).

65. The method of claim 61, wherein the abrasive particle comprises diamond.

66. The method of claim 61, wherein the coating comprises an average thickness of at least about 10 nm and not greater than about 1000 nm.

67. The method of claim 61, wherein the coating comprises domains having an average domain size of not greater than about 260 nm, and the coating further comprising less than 10 macro nodules per 100 microns² of an external surface of the coating.
